(19) United States
(12) Patent Application Publication
(10) Pub. No.: US 2025/0324133 A1
(43) Pub. Date: Oct. 16, 2025

(54) INDICATION AND INTERACTION FOR VIDEO MATCHING

(71) Applicant: Beijing Zitiao Network Technology Co., Ltd., Beijing (CN)

(72) Inventor: Weijie Wang, Beijing (CN)

(21) Appl. No.: 19/177,322

(22) Filed: Apr. 11, 2025

Related U.S. Application Data
(63) Continuation of application No. PCT/CN2024/087620, filed on Apr. 12, 2024.

(51) Int. Cl. H04N 21/44; H04N 21/472

(52) U.S. Cl. CPC H04N 21/44008; H04N 21/472

(57) ABSTRACT

According to embodiments of the disclosure, a method, apparatus, electronic device, medium and product for video matching are provided. In the method, a first playback interface of a first video and a second playback interface of a second video are presented. Based on a content match result between the first video and the second video, first match indication information is presented in an area associated with the first playback interface and second match indication information is presented in an area associated with the second playback interface. The first match indication information comprises a respective visual style indication corresponding to each of at least one first segment, and the second match indication information comprises a respective visual style indication corresponding to each of at least one second segment.

### CROSS-REFERENCE

This application is a continuation of and claims priority to International Application No. PCT/CN2024/087620, filed on Apr. 12, 2024, and entitled ‘INDICATION AND INTERACTION FOR VIDEO MATCHING’, which is incorporated herein by reference in its entirety.

### FIELD

Example embodiments of the present disclosure relate generally to the field of computers, and in particular, to a method, apparatus, electronic device, computer readable storage medium and computer program product for video matching.

### BACKGROUND

With the fast development of computer technology, a variety of videos has grown rapidly. In some scenarios, it is necessary to determine whether there exist matching contents between two or more videos. To fulfill a need of a user for matching a certain segment in one video with at least one segment in a further video, video matching tasks have emerged. Therefore, with the diversity of video contents, it is increasingly important to provide users with more intuitive match indication information.

### SUMMARY

In a first aspect of the preset disclosure, a method for video matching is provided. The method includes: presenting a first playback interface of a first video and a second playback interface of a second video; and based on a content match result between the first video and the second video, presenting first match indication information in an area associated with the first playback interface and second match indication information in an area associated with the second playback interface, wherein the first match indication information includes a respective visual style indication corresponding to each of at least one first segment in the first video, and the second match indication information includes a respective visual style indication corresponding to each of at least one second segment in the second video, and wherein a first segment of the first video and a second segment of the second video that are indicated by the content match result as matched with each other are corresponding to same visual style indications, and a first segment of the first video and a second segment of the second video that are indicated by the content match result as unmatched with each other are corresponding to different visual style indications.

In a second aspect of the preset disclosure, an apparatus for video matching is provided. The apparatus includes: an interface presenting model configured to present a first playback interface of a first video and a second playback interface of a second video; and an information presenting model configured to, based on a content match result between the first video and the second video, present first match indication information in an area associated with the first playback interface and second match indication information in an area associated with the second playback interface, wherein the first match indication information includes a respective visual style indication corresponding to each of at least one first segment in the first video, and the second match indication information includes a respective visual style indication corresponding to each of at least one second segment in the second video, and wherein a first segment of the first video and a second segment of the second video that are indicated by the content match result as matched with each other are corresponding to same visual style indications, and a first segment of the first video and a second segment of the second video that are indicated by the content match result as unmatched with each other are corresponding to different visual style indications.

In a third aspect of the present disclosure, an electronic device is provided. The device includes: at least one processing unit; and at least one memory coupled to the at least one processing unit and storing instructions executable by the at least one processing unit. The instructions, when performed by the at least one processing unit, cause the device to perform the method of the first aspect.

In a fourth aspect of the present disclosure, a computer-readable storage medium is provided. The computer readable storage medium stores a computer program thereon which, when executed by a processor, performs the method of the first aspect.

In a fifth aspect of the present disclosure, a computer program product is provided. The computer program product is tangibly stored in a computer storage medium and including computer-executable instructions which, when executed by a device, cause the device to perform the method of the first aspect.

It should be understood that the content described in this section is not intended to limit key or important features of embodiments of the present disclosure, nor is it intended to limit the scope of the present disclosure. Other features of the present disclosure will become easily comprehensible through the following description.

### BRIEF DESCRIPTION OF THE DRAWINGS

In conjunction with the accompanying drawings and with reference to the following detailed description, the above and other features, advantages, and aspects of various embodiments of the present disclosure will become more apparent. In the figures, the same or similar reference numbers refer to the same or similar elements, wherein:

FIG. 1 illustrates a schematic diagram of an example environment in which embodiments of the present disclosure may be implemented;

FIGS. 2A to 2B illustrate schematic diagrams of example user interfaces for video matching according to some embodiments of the present disclosure;

FIG. 3 illustrates a flowchart of a process of video matching according to some embodiments of the present disclosure;

FIG. 4 illustrates a schematic structural block diagram of an apparatus for video matching according to some certain embodiments of the present disclosure; and

FIG. 5 illustrates a block diagram of an electronic device capable of implementing one or more embodiments of the present disclosure.

### DETAILED DESCRIPTION

The embodiments of the present disclosure will be described in more detail below with reference to the accompanying drawings. Although certain embodiments of the present disclosure are shown in the drawings, it would be appreciated that the present disclosure may be implemented in various forms and should not be interpreted as limited to the embodiments described in this specification. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

In the description of the embodiments of the present disclosure, the term ‘including’ and similar terms would be appreciated as open-ended inclusion, that is, ‘including but not limited to’. The term ‘based on’ would be appreciated as ‘at least partially based on’. The term ‘one embodiment’ or ‘the embodiment’ would be appreciated as ‘at least one embodiment’. The term ‘some embodiments’ would be appreciated as ‘at least some embodiments’. Other explicit and implicit definitions may also be included below.

In the present disclosure, unless expressly stated, performing a step ‘in response to A’ does not mean performing the step immediately after ‘A’, but may include one or more intermediate steps.

It would be appreciated that the data involved in this technical solution (including but not limited to the data itself, data acquisition or use) shall comply with the requirements of corresponding laws, regulations and relevant provisions.

It would be understood that, before using the technical solutions disclosed in the embodiments of the present disclosure, the types, the usage scope, the usage scenario, etc., of personal information, involved in the present disclosure should be notified to the user in a suitable manner according to the relevant laws and regulations, and the authorization of the user should be obtained.

For example, in response to an active request being received from a user, a prompt message is sent to the user to explicitly prompt the user that the operation requested by the user would need acquisition and use of personal information of the user. As such, according to prompt information, users may choose whether to provide personal information to the software or hardware, such as an electronic device, application, server or storage medium, that performs the operations of the technical solution of the present disclosure.

As an optional but non-limiting implementation, in response to the active request being received from the user, the prompt information may be sent to the user via, for example, a pop-up window in which the prompt information may be presented in text. In addition, the pop-up window may also contain selection controls configured for the user to choose ‘agree’ or ‘disagree’ to provide the personal information to the electronic device.

It would be appreciated that the above process of notification and acquisition of user authorization is only an example and do not limit the implementations of the present disclosure. Other methods that meet relevant laws and regulations may also be applied to the implementations of the present disclosure.

As briefly described above, to fulfill a need of a user for matching a certain segment in one video with at least one segment in a further video, video matching tasks have emerged. For example, if one video is created based on a further video, or both videos are generated based on the same content source or the same scene shot, there may be partially matching video segments in them. When performing video matching, the video content may be analyzed to determine whether the same or similar content segments exist in a plurality of videos. The video match results need to be presented to the user in a visual manner.

A plurality of videos might have a plurality of matching video segments, which might appear anywhere in each video and vary in length. Thus, it is a problem concerning how to present users with an accurate and convenient match relationship indications. Simple annotations may not allow users to visualize which video contents are matched with each other. When matched segments in the video account for a small proportion in the progress bar, it may be difficult for the user to quickly hit the segments for viewing.

In view of this, the embodiments of the present disclosure provide an improved method for video matching. In the solution, a first playback interface of a first video and a second playback interface of a second video are presented. Then, based on a content match result between the first video and the second video, first match indication information is presented in an area associated with the first playback interface and second match indication information is presented in an area associated with the second playback interface. The first match indication information includes a respective visual style indication corresponding to each of at least one first segment in the first video, and the second match indication information includes a respective visual style indication corresponding to each of at least one second segment in the second video. Accordingly, a first segment of the first video and a second segment of the second video that are indicated by the content match result as matched with each other are corresponding to same visual style indications, and a first segment of the first video and a second segment of the second video that are indicated by the content match result as unmatched with each other are corresponding to different visual style indications.

In this way, it is more convenient and intuitive for the user to view which segments in different videos are matched with each other. In addition, in some embodiments, it is possible to determine the location of these segments in the video or material and the proportion to the total duration from the match indication information. It is further possible to synchronize the playback of match segments in different videos based on the user selection, so as to check whether the match result is reasonable or not. Moreover, when there are video segments in the video that have been subjected to variable speed processing, synchronized playback may also be implemented to fulfill the purpose of frame-by-frame comparison.

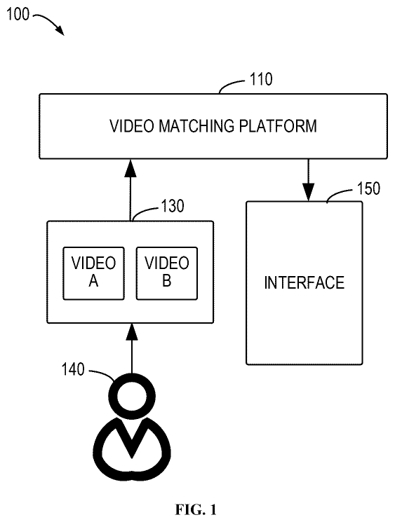

FIG. 1 illustrates a schematic diagram of an example environment 100 in which the embodiments of the present disclosure may be implemented. The environment 100 includes a video matching platform 110, a user 140, and a video group 130 for which content matching is to be performed. The video group 130 may be uploaded by the user 140 or otherwise designated for video matching. The video group 130 may include a plurality of videos. In FIG. 1, two videos, i.e., video A and video B, are illustrated by way of example. In some embodiments, the video group 130 uploaded by the user 140 may further include video A, video B and further videos, and the present disclosure is not intended to limit in this regard.

In the environment 100 of FIG. 1, the video matching platform 110 performs a video matching task based on a plurality of videos uploaded or specified by the user 140 and presents an interface/page 150 based on a content match result. This interface/page 150 may include any suitable page that may be provided to indicate to the user the content match result for the plurality of videos. The interface/page 150 is sometimes referred to herein as a ‘match result presenting page’.

The video matching platform 110 may run on an appropriate electronic device. The electronic device herein may be any type of computing-capable device, including a terminal device and/or a server-side device. The terminal device may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a gaming device, or any combination of the foregoing, including accessories and peripherals for such devices or any combination thereof. The server-side device may, for example, include a computing system/server, such as a mainframe, an edge computing node, a computing device in cloud environments, and the like. In some embodiments, the video matching platform 110 may be implemented based on cloud services.

It should be understood that the structure and functionality of the various elements of the environment 100 are described for example purposes only and do not imply any limitations on the scope of the present disclosure.

Various example implementations of the present disclosure will be described in detail below.

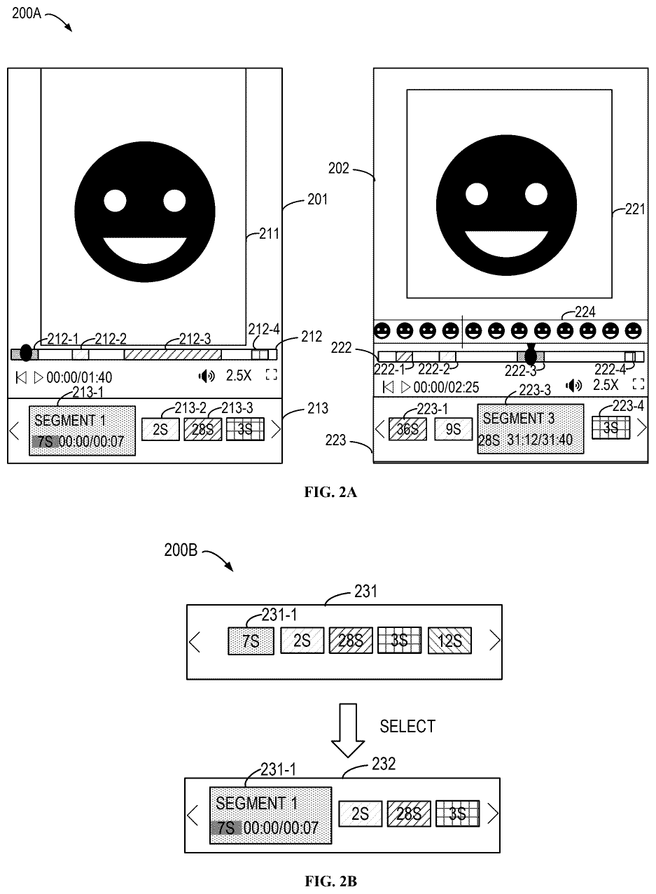

Example embodiments of image processing are described below with reference to the example interfaces/example pages shown in FIGS. 2A to 2B.

For the sole purpose of better understanding the various embodiments of the present disclosure, reference is made to example user interfaces 200A through 200B shown in FIGS. 2A to 2B in the example embodiments below. FIGS. 2A to 2B illustrate schematic diagrams of the example user interfaces 200A through 200B for video matching according to some embodiments of the present disclosure. It should be understood that the user interfaces illustrated in FIGS. 2A to 2B, and other accompanying drawings below are merely examples, and various designs may actually exist. For example, respective graphical elements and/or controls in the user interface may have different arrangements and visual representations, wherein one or more of the elements and/or controls may be omitted or replaced, and one or more elements and/or controls may further exist. In addition, the user interface may contain any suitable content. The scope of the present disclosure is not limited in this regard.

In example embodiments of the present disclosure, the example user interfaces 200A through 200B may be presented at the video matching platform 110. For ease of discussion, some embodiments of the present disclosure will be described with reference to the environment 100 of FIG. 1 and the example user interfaces 200A through 200B. While these embodiments have been described as being implemented at the video matching platform 110 of FIG. 1, and in particular at an application client of the video matching platform 110, in further embodiments, the video matching platform 110 may perform these operations with the assistance of a server device.

In the example of FIG. 2, assume that the video group performing content matching includes a first video and a second video. In the match result presenting page, the video matching platform 110 presents a first playback interface of the first video and a second playback interface of the second video in a result presenting area. As shown in the example user interface 200A of FIG. 2A, the video matching platform 110 presents a first playback interface 201 of the first video and a second playback interface 202 of the second video in the result presenting area.

In some examples, the playback interface includes at least a video screen and a progress bar. As shown in the example user interface 200A of FIG. 2A, the first playback interface 201 includes at least a video screen 211 and a progress bar 212. The second playback interface 202 includes at least a video screen 221 and a progress bar 222.

In some embodiments, based on a content match result between the first video and the second video, the video matching platform 110 presents first match indication information in an area associated with the first playback interface. Accordingly, the video matching platform 110 also presents second match indication information in an area associated with the second playback interface.

In some examples, the video matching platform 110 may match the first video with the second video to determine a content match result between the first video and the second video. The content match result may indicate a match relationship between one or more segments in the first video and one or more segments in the second video. For example, one segment in the first video may be matched to one or more segments in the second video. A pair of segments in two videos matching each other means that a content similarity of the pair of segments is relatively high or reaches a certain threshold. The video matching platform 110 may determine whether a pair of segments in videos is matched with each other based on any content matching criterion by using any appropriate video matching technique. The embodiments of the present disclosure do not limit how the video matching platform determines the content match result.

Based on the content match result between the first video and the second video, the video matching platform 110 presents the first match indication information and the second match indication information in associated areas corresponding to the first playback interface and the second playback interface, respectively.

The areas for presenting the match indication information in the first playback interface and/or the second playback interface may include a progress bar within the respective playback interface, and/or a match presenting area independent of the playback interface. As in the example user interface 200A shown in FIG. 2A, the area associated with the first playback interface includes the progress bar 212, and/or a match presenting area 213 below. The area associated with the second playback interface includes the progress bar 222, and/or a match presenting area 223 below the playback interface. Still with reference to FIGS. 2A to 2B, a detailed description will be presented regarding that the video matching platform 110 presents the first match indication information and/or the second match indication information at the progress bar associated with the first playback interface and/or the second playback interface, respectively, and/or in the match presenting area below.

The first match indication information and/or the second match indication information includes color elements on the progress bar, and/or a match segment presentation below. As shown in the example user interface 200A of FIG. 2A, the first match indication information includes color elements on the progress bar 212, and/or a match segment presentation below. The second match indication information includes color elements on the progress bar 222, and/or a match segment presentation below.

In some examples, the first match indication information and/or the second match indication information may include a progress bar. The first match indication information and/or the second match indication information may include a progress bar and a match segment presenting area below. The present disclosure is not intended to limit in this regard.

In some embodiments, the first match indication information includes a respective visual style indication corresponding to each of at least one first segment in the first video, and the second match indication information includes a respective visual style indication corresponding to each of at least one second segment in the second video.

Accordingly, a first segment of the first video and a second segment of the second video that are indicated by the content match result as matched with each other are corresponding to same visual style indications, and a first segment of the first video and a second segment of the second video that are indicated by the content match result as unmatched with each other are corresponding to different visual style indications.

In some embodiments, optional visual style indications include, but are not limited to, color-based visual style indications, fill pattern-based visual style indications, graphic-based visual style indications, and any other visual styles that may be visually distinguished from one another. For example, segments that are matched with each other may be indicated by the same colors, segments that are unmatched with each other may be indicated by different colors, and so forth. In the examples of FIGS. 2A and 2B, different fill patterns are used as examples of different visual style indications. Certainly, a certain color-based visual style indication and a fill pattern-based visual style indication may also be considered different from each other. The embodiments of the present disclosure are not intended to specifically limit specific visual styles, which may be selected and configured as needed in practical applications.

As shown in FIG. 2A, the video matching platform 110 may match the first video 211 with the second video 221 to obtain four segments with a content match between the first video 211 and the second video 221 (e.g., the segment 1 of the first video 211 matches the segment 3 of the second video 221, the segment 2 of the first video 211 matches the second video 221, the segment 3 of the first video 211 matches the segment 1 of the second video 221, and the segment 4 of the first video 211 matches the segment 4 of the second video 221). Based on the match result between the first video 211 and the second video 221, the video matching platform 110 presents information of four different visual style indications (e.g., visual style indications 212-1, 212-2, 212-3, 212-4 with four different fill patterns) in the area associated with the first playback interface 201 (e.g., the area corresponding to the progress bar 212).

Accordingly, the video matching platform 110 also presents information of four different visual style indications (e.g., visual style indications 222-1, 222-2, 222-3, 222-4 with four different fill patterns) in the area associated with the second playback interface 202 (e.g., the area corresponding to the progress bar 222). In some examples, visual style indications for the first segment of the first video 211 and the second segment of the second video 221 that are matched with each other are the same in the video matching platform 110.

For example, when the first segment of the first video 211 and the second segment of the second video 221 are matched video contents, then a visual style indication 212-1 about the first segment in the area corresponding to the progress bar 212 is the same as the visual style indication corresponding to the progress bar 222 in the video matching platform 110.

When the first segment of the first video 211 and the second segment of the second video 221 are unmatched video contents, then the visual style indication 212-1 about the first segment in the area corresponding to the progress bar 212 is different from the visual style indication corresponding to the progress bar 222 in the video matching platform 110.

Still with reference to FIGS. 2A to 2B, a description will be presented regarding that the video matching platform 110 presents the first match indication information and/or the second match indication information in the progress bar and/or in the match presenting area below associated with the first playback interface and/or the second playback interface, respectively.

First with reference to FIG. 2A, a description is presented regarding that the video matching platform 110 presents the first match indication information and/or the second match indication information at a progress bar associated with the first playback interface and/or the second playback interface, respectively.

In some embodiments, the video matching platform 110 presents the first match indication information on a first progress bar of the first playback interface or in an adjacent area to the first progress bar. The video matching platform 110 presents the first match indication information (e.g., a color element, a fill pattern, etc.) on the first progress bar 212 of the first playback interface 201 or in an additional area adjacent to the first progress bar 212.

In some embodiments, the video matching platform 110 presents the second match indication information on a second progress bar of the second playback interface or in an adjacent area to the second progress bar. The video matching platform 110 presents the second match indication information (e.g., a color element, a fill pattern, etc.) on the second progress bar 222 of the second playback interface 202 or in an additional area adjacent to the second progress bar 222.

In some embodiments, an extended length indicated by a respective visual style indication corresponding to each of the at least one first segment is the same as a length of a corresponding first segment on the first progress bar or in the adjacent area to the first progress bar.

In some examples, an extended length indicated by a respective visual style indication corresponding to each of the at least one first segment is the same as a length of a corresponding first segment on the first progress bar 212 or in the adjacent area to the first progress bar 212. For example, the length of the visual style indication 212-1 of the first segment on the first progress bar 212 is the same as a video segment time length corresponding to the first segment. The length of a visual style indication 212-2 of the first segment on the first progress bar 212 is the same as the video segment time length corresponding to the first segment.

In some embodiments, an extended length indicated by a respective visual style indication corresponding to each of the at least one second segment is the same as a length of a corresponding second segment on the second progress bar or in the adjacent area to the second progress bar.

In some examples, an extended length indicated by a respective visual style indication corresponding to each of the at least one second segment is the same as a length of a corresponding second segment on the second progress bar 222 or in the adjacent area to the second progress bar 222. For example, the length of a visual style indication 222-3 of the second segment on the second progress bar 222 is the same as the video segment time length corresponding to the second segment. The length of the visual style indication 222-1 of the second segment on the second progress bar 222 is the same as the video segment time length corresponding to the second segment.

Still with reference to FIGS. 2A to 2B, a description will be presented regarding that the video matching platform 110 presents the first match indication information and/or the second match indication information in an area associated with the first playback interface and/or the second playback interface, respectively (e.g., a match display area below the first playback interface and/or the second playback interface).

In some embodiments, the video matching platform 110 presents the first match indication information in a first area outside the first playback interface. In some embodiments, the video matching platform 110 presents the first match indication information in a match presenting area 213 below and associated with the first playback interface 201.

In some embodiments, the video matching platform 110 presents the second match indication information in a second area outside the second playback interface. In some embodiments, the video matching platform 110 presents the second match indication information in a match presentation region 223 below and associated with the second playback interface 202.

In some embodiments, a size of a respective visual style indication corresponding to each of the at least one first segment in the first area is not proportional to a length of the corresponding first segment. Accordingly, a size of a respective visual style indication corresponding to each of the at least one second segment in the second area is not proportional to a length of the corresponding second segment.

As shown in FIG. 2A, in the first area (e.g., the match presenting area 213 below the first playback interface 201), the sizes of the visual style indication 213-2 corresponding to a first segment are not proportional to the length of the corresponding first segment. In the first area, the sizes of the visual style indication 213-3 corresponding to a first segment are also not proportional to the length of the corresponding first segment.

In the second area (e.g., the match presenting area 223 below the second playback interface 202), the sizes of the visual style indication 223-1 corresponding to a second segment are not proportional to the length of the corresponding second segment. In the second area, the sizes of the visual style indication 223-4 corresponding to a second segment are also not proportional to the length of the corresponding second segment.

In some embodiments, when the match indication information is presented in the match presenting area below, the sizes of the presented visual style indication are not strongly correlated to the length of the match segment. In this way, even if the length of a certain segment is short, the visual style indication corresponding to the segment may still have such sizes that may be easily selected by the user for viewing.

In some embodiments, the sizes of the visual style indications corresponding to the plurality of first segments may be the same, and the sizes of the visual style indications corresponding to the plurality of second segments may also be the same, completely independent of the length of these segments. In some embodiments, among the plurality of first segments, the sizes of the visual style indications corresponding to the relatively long first segments may be longer (e.g., of longer length) than the sizes of the visual style indications corresponding to the relatively short first segments. For the plurality of second segments, the sizes of the visual style indications may be set based on similar rules.

In some embodiments, a size of a respective visual style indication corresponding to each of the at least one first segment in the first area is equal to or exceed a lower limit size. Accordingly, a size of a respective visual style indication corresponding to each of the at least one second segment in the second area is equal to or exceed the lower limit size.

In some examples, by setting a lower limit sizes, regardless of the length of the segments for which match indications are to be provided, the sizes of the block in the lower match presenting area are always longer than or equal to the lower limit sizes. This further makes it easier for the user to select and view.

In some embodiments, in response to detecting a selection of a first visual style indication corresponding to a target first segment in the first area, the video matching platform 110 expands the first visual style indication in the first area. Accordingly, in response to detecting a selection of a second visual style indication corresponding to a target second segment in the second area, the video matching platform 110 expands the second visual style indication in the second area.

In some examples, when the video matching platform 110 detects that the user 140 selects a first visual style indication 213-1 corresponding to a target first segment in the match presenting area 213, the first visual style indication 213-1 is expanded in the match presenting area 213. When the video matching platform 110 detects that the user 140 selects a second visual style indication 223-3 corresponding to a target second segment in the match presenting area 223, the second visual style indication 223-3 is expanded in the match presenting area 223.

In some embodiments, in response to the first visual style indication being expanded, the video matching platform 110 presents, in association with the expanded first visual style indication, a time range occupied by the target first segment in the first video. Similarly, in response to the second visual style indication being expanded, the video matching platform 110 presents, in association with the expanded second visual style indication, a time range occupied by the target second segment in the second video.

For example, in FIG. 2A, when the visual style indication 213-1 of the segment 1 in the first video is expanded, the video matching platform 110 presents a time range occupied by the segment in the first video superimposed on the expanded visual style indication 213-1, for example a segment length of 7S and an occupied time range of: 00:00-00:07.

When the visual style indication 223-3 of the segment 3 in the second video is expanded, the video matching platform 110 will present the time range occupied by the segment 3 in the second video in association with the expanded visual style indication 223-3, for example a segment length of 28S and an occupied time range of: 31:12-31:40.

For ease of understanding, a description will be presented below with reference to FIG. 2B, where in response to detecting a selection of the first visual style indication and/or the second visual style indication corresponding to the target first segment and/or the target second segment in the first area and/or the second area, the video matching platform 110 expands the first visual style indication and/or the second visual style indication in the first area and/or the second area. Hereinafter, for ease of understanding, the first area and/or the second area will be collectively referred to as the match presenting area, the target first segment and/or the target second segment will be collectively referred to as the target segment, and the first visual style indication and/or the second visual style indication will be collectively referred to as the visual style indication. However, this is merely an example, and the present disclosure is not intended to limit in this regard.

As in the example interface 200B shown in FIG. 2B, when the video matching platform 110 detects a selection of the target segment by the user 140 in the match presenting area 231, the visual style indication 231-1 corresponding to the target segment is expanded in the match presenting area 231. The match presenting area 232 as shown in FIG. 2B is a presentation form after the visual style indication 231-1 corresponding to the target segment is expanded.

When the visual style indication 231-1 corresponding to the target segment is expanded, the video matching platform 110 will present the time range occupied by the target segment in the video to which the target segment 231-1 belongs in association with the expanded visual style indication. For example, the segment 1 occupies a time of 7S in the video to which it belongs, and then the time range is 00:00-00:07.

The description has been presented above regarding the video matching platform 110 presenting the first match indication information and/or the second match indication information in the progress bar and/or in the match display area below associated with the first playback interface and/or the second playback interface, respectively.

With reference to FIG. 2A, a description will be presented below, where the user selects a visual style indication corresponding to a segment and a secondary progress bar corresponding to the segment is presented, to make it convenient for the user to view each frame corresponding to the segment.

In some embodiments, in response to detecting a selection of a first visual style indication corresponding to a target first segment in the first match indication information, the video matching platform 110 presents a secondary progress bar corresponding to the target first segment in an area other than a first progress bar of the first playback interface. The secondary progress bar is longer than a length of the target first segment. In some examples, the user 140 may view each frame corresponding to the target first segment based on the secondary progress bar.

When the user 140 selects the visual style indication 212-1 corresponding to a target first segment in the first progress bar 212 corresponding to the target first segment in the first matching indication information, the video matching platform 110 presents a secondary progress bar corresponding to the target first segment in an area other than the first progress bar 212.

Additionally, when the user 140 selects the visual style indication 213-1 corresponding to a target first segment in the match presenting area 213 corresponding to the target first segment in the first match indication information, the video matching platform 110 may jump to a location of the visual style indication 212-1 corresponding to the target first segment in the first progress bar 212, and presents a secondary progress bar corresponding to the target first segment in an area outside the first progress bar 212.

Accordingly, in response to detecting a selection of a second visual style indication corresponding to a target second segment in the second match indication information, the video matching platform 110 presents a secondary progress bar corresponding to the target second segment in an area other than a second progress bar of the second playback interface. The secondary progress bar is longer than a length of the target second segment. In some examples, the user 140 may view each frame corresponding to the target second segment based on the secondary progress bar.

When the user 140 selects the visual style indication 222-3 corresponding to a target second segment in the second progress bar 222 corresponding to the target second segment in the second match indication information, the video matching platform 110 presents a secondary progress bar 224 corresponding to the target second segment in an area outside the second progress bar 222.

Additionally, when the user 140 selects the visual style indication 223-3 corresponding to a target second segment in the match presenting area 223 corresponding to the target second segment in the second match indication information, the video matching platform 110 may jump to a location of the visual style indication 222-3 corresponding to the target second segment in the second progress bar 222, and present the secondary progress bar 224 corresponding to the target second segment in an area outside the second progress bar 222 so that the user 140 may view the second segment frame by frame.

In some embodiments, whether a visual style indication corresponding to a segment in the first video or the second video is selected on the progress bar, a secondary progress bar corresponding to the selected segment may be presented. Since the secondary progress bar is longer, it may be convenient for the user to select various locations of the segment in the secondary progress bar.

In some embodiments, the video matching platform 110 presenting first match indication information in an area associated with the first playback interface includes presenting, in association with the first match indication information, a respective length indication of each of the at least one first segment.

In the example user interface 200A as shown in FIG. 2A, when a first segment (e.g., the segment 1) of the first video matches a second segment (e.g., the segment 3) of the second video, the video matching platform 110 presents a length indication (e.g., 7S) of the first segment on the first visual style indication 213-1 corresponding to the first segment in the area (e.g., the match presenting area 213) associated with the first playback interface 201 of the first video.

In some embodiments, the video matching platform 110 presenting second match indication information in an area associated with the second playback interface includes presenting, in association with the second match indication information, a respective length indication of each of the at least one second segment.

In the example user interface 200A as shown in FIG. 2A, when a first segment (e.g., the segment 1) of the first video matches a second segment (e.g., the segment 3) of the second video, the video matching platform 110 presents a length indication (e.g., 28S) of the second segment on the second visual style indication 223-3 corresponding to the second segment in the area (e.g., the match presenting area 223) associated with the second playback interface 202 of the second video.

In some embodiments, while the figure only shows presenting the length indications of the respective segments at the match indication information in the match presenting area, alternatively or in addition, the length indications of the respective segments may further be presented at the match indication information at the respective progress bars of the first video and the second video or in the adjacent area to the progress bars. The embodiments of the present disclosure are not intended to limit in this regard.

Various embodiments for presenting the match indication information of match segments in two videos have been described above in conjunction with the match between the videos. It should be understood that the embodiments of the present disclosure may further be similarly applied to scenarios where three or more videos are subjected to matching. In such scenarios, based on content match results of the three or more videos, the match indication information as discussed in the embodiments of the present disclosure may be used to indicate video segments in the three or more videos that matched with each other, in order to allow a user to quickly understand and determine which segments in those videos matched with each other, and to obtain more information related to the match segments. In addition, support is further provided to the user to easily and quickly view individual segments in individual videos.

In summary, by means of the match indication information (e.g., a color element or any other visual indication), it is possible to more visibly correspond pairs of match segments in the first video with those in the second video on the progress bar and/or other associated area. With the match presenting area, it becomes easier for the user to select and view the match segments. Further, in some scenarios (e.g., when segments occupy a particularly short length on the progress bar), it is easier for the user to perform refined selection operations by providing a secondary progress bar.

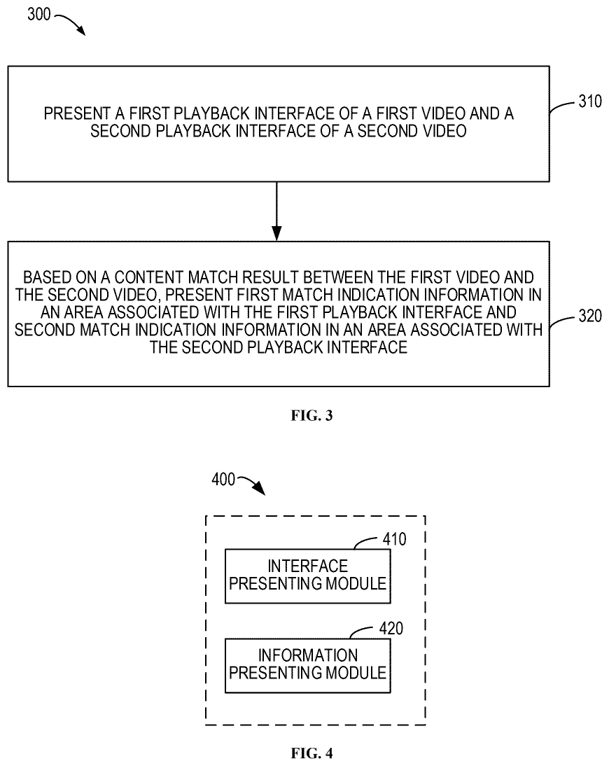

FIG. 3 illustrates a flowchart of a process 300 for video matching according to some embodiments of the present disclosure. The process 300 may be implemented at the video matching platform 110. The process 300 is described below with reference to FIG. 1.

At block 310, the video matching platform 110 presents a first playback interface of a first video and a second playback interface of a second video.

At block 320, based on a content match result between the first video and the second video, the video matching platform 110 presents first match indication information in an area associated with the first playback interface and second match indication information in an area associated with the second playback interface, wherein the first match indication information includes a respective visual style indication corresponding to each of at least one first segment in the first video, and the second match indication information includes a respective visual style indication corresponding to each of at least one second segment in the second video, and wherein a first segment of the first video and a second segment of the second video that are indicated by the content match result as matched with each other are corresponding to same visual style indications, and a first segment of the first video and a second segment of the second video that are indicated by the content match result as unmatched with each other are corresponding to different visual style indications.

In some embodiments, presenting first match indication information in an area associated with the first playback interface and second match indication information in an area associated with the second playback interface includes: presenting the first match indication information on a first progress bar of the first playback interface or in an adjacent area to the first progress bar; and presenting the second match indication information on a second progress bar of the second playback interface or in an adjacent area to the second progress bar

In some embodiments, an extended length indicated by a respective visual style indication corresponding to each of the at least one first segment is the same as a length of a corresponding first segment on the first progress bar or in the adjacent area to the first progress bar; and an extended length indicated by a respective visual style indication corresponding to each of the at least one second segment is the same as a length of a corresponding second segment on the second progress bar or in the adjacent area to the second progress bar.

In some embodiments, presenting first match indication information in an area associated with the first playback interface and second match indication information in an area associated with the second playback interface includes: presenting the first match indication information in a first area outside the first playback interface; and presenting the second match indication information in a second area outside the second playback interface

In some embodiments, a size of a respective visual style indication corresponding to each of the at least one first segment in the first area is not proportional to a length of the corresponding first segment; and a size of a respective visual style indication corresponding to each of the at least one second segment in the second area is not proportional to a length of the corresponding second segment.

In some embodiments, a size of a respective visual style indication corresponding to each of the at least one first segment in the first area is equal to or exceed a lower limit size, and wherein a size of a respective visual style indication corresponding to each of the at least one second segment in the second area is equal to or exceed the lower limit size.

In some embodiments, the process 300 further includes: in response to detecting a selection of a first visual style indication corresponding to a target first segment in the first area, expanding the first visual style indication in the first area; and/or in response to detecting a selection of a second visual style indication corresponding to a target second segment in the second area, expanding the second visual style indication in the second area.

In some embodiments, the process 300 further includes: in response to the first visual style indication being expanded, presenting, in association with the expanded first visual style indication, a time range occupied by the target first segment in the first video; and/or in response to the second visual style indication being expanded, presenting, in association with the expanded second visual style indication, a time range occupied by the target second segment in the second video.

In some embodiments, the process 300 further includes: in response to detecting a selection of a first visual style indication corresponding to a target first segment in the first match indication information, presenting a secondary progress bar corresponding to the target first segment in an area other than a first progress bar of the first playback interface, the secondary progress bar being longer than a length of the target first segment; and/or in response to detecting a selection of a second visual style indication corresponding to a target second segment in the second match indication information, presenting a secondary progress bar corresponding to the target second segment in an area other than a second progress bar of the second playback interface, the secondary progress bar being longer than a length of the target second segment.

In some embodiments, presenting first match indication information in an area associated with the first playback interface and second match indication information in an area associated with the second playback interface includes: presenting, in association with the first match indication information, a respective length indication of each of the at least one first segment; and presenting, in association with the second match indication information, a respective length indication of each of the at least one second segment.

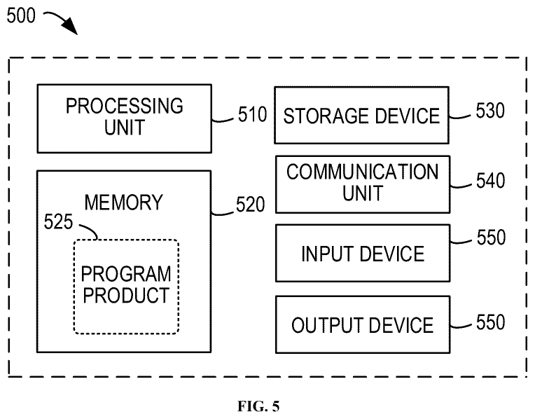

FIG. 4 illustrates a schematic structural block diagram of an apparatus 400 for video matching according to certain embodiments of the present disclosure. The apparatus 400 may be implemented as or included in the video matching platform 110. Individual modules/components in the apparatus 400 may be implemented by hardware, software, firmware, or any combination thereof.

As shown, the apparatus 400 includes an interface presenting model 410 configured to present a first playback interface of a first video and a second playback interface of a second video. The apparatus 400 further includes an information presenting model 420 configured to, based on a content match result between the first video and the second video, present first match indication information in an area associated with the first playback interface and second match indication information in an area associated with the second playback interface, wherein the first match indication information includes a respective visual style indication corresponding to each of at least one first segment in the first video, and the second match indication information includes a respective visual style indication corresponding to each of at least one second segment in the second video, and wherein a first segment of the first video and a second segment of the second video that are indicated by the content match result as matched with each other are corresponding to same visual style indications, and a first segment of the first video and a second segment of the second video that are indicated by the content match result as unmatched with each other are corresponding to different visual style indications.

In some embodiments, presenting first match indication information in an area associated with the first playback interface and the information presenting model 420 is further configured to: present the first match indication information on a first progress bar of the first playback interface or in an adjacent area to the first progress bar; and present the second match indication information on a second progress bar of the second playback interface or in an adjacent area to the second progress bar.

In some embodiments, an extended length indicated by a respective visual style indication corresponding to each of the at least one first segment is the same as a length of a corresponding first segment on the first progress bar or in the adjacent area to the first progress bar; and an extended length indicated by a respective visual style indication corresponding to each of the at least one second segment is the same as a length of a corresponding second segment on the second progress bar or in the adjacent area to the second progress bar.

In some embodiments, presenting first match indication information in an area associated with the first playback interface and the information presenting model 420 is further configured to: present the first match indication information in a first area outside the first playback interface; and present the second match indication information in a second area outside the second playback interface.

In some embodiments, a size of a respective visual style indication corresponding to each of the at least one first segment in the first area is not proportional to a length of the corresponding first segment; and a size of a respective visual style indication corresponding to each of the at least one second segment in the second area is not proportional to a length of the corresponding second segment.

In some embodiments, a size of a respective visual style indication corresponding to each of the at least one first segment in the first area is equal to or exceed a lower limit size, and wherein a size of a respective visual style indication corresponding to each of the at least one second segment in the second area is equal to or exceed the lower limit size.

In some embodiments, the apparatus 400 further includes an indication expanding module configured to: in response to detecting a selection of a first visual style indication corresponding to a target first segment in the first area, expand the first visual style indication in the first area; and/or in response to detecting a selection of a second visual style indication corresponding to a target second segment in the second area, expand the second visual style indication in the second area.

In some embodiments, the apparatus 400 further includes a range presenting module configured to: in response to the first visual style indication being expanded, present, in association with the expanded first visual style indication, a time range occupied by the target first segment in the first video; and/or in response to the second visual style indication being expanded, present, in association with the expanded second visual style indication, a time range occupied by the target second segment in the second video.

In some embodiments, the apparatus 400 further includes a progress bar presenting module configured to: in response to detecting a selection of a first visual style indication corresponding to a target first segment in the first match indication information, present a secondary progress bar corresponding to the target first segment in an area other than a first progress bar of the first playback interface, the secondary progress bar being longer than a length of the target first segment; and/or in response to detecting a selection of a second visual style indication corresponding to a target second segment in the second match indication information, present a secondary progress bar corresponding to the target second segment in an area other than a second progress bar of the second playback interface, the secondary progress bar being longer than a length of the target second segment.

In some embodiments, presenting first match indication information in an area associated with the first playback interface and the information presenting model 420 is further configured to: present, in association with the first match indication information, a respective length indication of each of the at least one first segment; and present, in association with the second match indication information, a respective length indication of each of the at least one second segment.

FIG. 5 shows a block diagram of an electronic device 500 in which one or more embodiments of the present disclosure may be implemented. It should be understood that the electronic device 500 shown in FIG. 5 is merely an example and should not constitute any limitation on the functionality and scope of the embodiments described herein. The electronic device 500 shown in FIG. 5 may be applied to implement the video matching platform 110 of FIG. 1 or the apparatus 400 of FIG. 4.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor capable of performing various processes according to a program stored in the memory 520. In a multiprocessor system, a plurality of processing units execute computer-executable instructions in parallel to improve the parallel processing capabilities of electronic device 500.

The electronic device 500 typically includes a variety of computer storage media. Such media may be any available media that are accessible to the electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium that may be used to store information and/or data and that may be accessed within the electronic device 500.

The electronic device 500 may further include an additional removable/non-removable, volatile/non-volatile storage medium. Although not shown in FIG. 5, a disk drive for reading from or writing to a removable, non-volatile magnetic disk (e.g., a ‘floppy disk’) or an optical disk drive for reading from or writing to a removable, non-volatile optical disk may be provided. In these cases, each drive may be connected to a bus (not shown) by one or more data media interfaces. The memory 520 may include a computer program product 525 having one or more program modules configured to execute various methods or actions of the various embodiments of the present disclosure.

The communication unit 540 is configured to communicate with other electronic devices through a communication medium. Additionally, the functionality of components of the electronic device 500 may be implemented by a single computing cluster or multiple computing machines capable of communicating through a communication connection. Thus, the electronic device 500 may operate in a networked environment using a logical connection with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed. The external device, such as a storage device, a display device, etc., communicates with one or more devices that enable users to interact with the electronic device 500, or communicates with any device (e.g., a network card, a modem, etc.) that enables the electronic device 500 to communicate with one or more other electronic devices. Such communication may be performed via an input/output (I/O) interface (not shown).

According to example implementations of the present disclosure, a computer-readable storage medium having computer-executable instructions stored thereon is provided. The computer-executable instructions are performed by a processor to implement the method described above. According to example implementations of the present disclosure, a computer program product is further provided. The computer program product is tangibly stored on a non-transitory computer-readable medium and includes computer-executable instructions. The computer-executable instructions are performed by a processor to implement the method described above.

Various aspects of the present disclosure are described herein with reference to flow charts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates an apparatus to implement the functions/acts specified in one or more blocks in the flowchart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps may be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations of the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes may also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations of the present disclosure have been described above. The above description is an example, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

What is claimed is:

1. A method for video matching, comprising:
presenting a first playback interface of a first video and a second playback interface of a second video; and
based on a content match result between the first video and the second video, presenting first match indication information in an area associated with the first playback interface and second match indication information in an area associated with the second playback interface,
wherein the first match indication information comprises a respective visual style indication corresponding to each of at least one first segment in the first video, and the second match indication information comprises a respective visual style indication corresponding to each of at least one second segment in the second video, and
wherein a first segment of the first video and a second segment of the second video that are indicated by the content match result as matched with each other are corresponding to same visual style indications, and a first segment of the first video and a second segment of the second video that are indicated by the content match result as unmatched with each other are corresponding to different visual style indications.

2. The method of claim 1, wherein presenting first match indication information in an area associated with the first playback interface and second match indication information in an area associated with the second playback interface comprises:
presenting the first match indication information on a first progress bar of the first playback interface or in an adjacent area to the first progress bar; and
presenting the second match indication information on a second progress bar of the second playback interface or in an adjacent area to the second progress bar.

3. The method of claim 2, wherein an extended length indicated by a respective visual style indication corresponding to each of the at least one first segment is the same as a length of a corresponding first segment on the first progress bar or in the adjacent area to the first progress bar; and
wherein an extended length indicated by a respective visual style indication corresponding to each of the at least one second segment is the same as a length of a corresponding second segment on the second progress bar or in the adjacent area to the second progress bar.

4. The method of claim 1, wherein presenting first match indication information in an area associated with the first playback interface and second match indication information in an area associated with the second playback interface comprises:
presenting the first match indication information in a first area outside the first playback interface; and
presenting the second match indication information in a second area outside the second playback interface.

5. The method of claim 4, wherein a size of a respective visual style indication corresponding to each of the at least one first segment in the first area is not proportional to a length of the corresponding first segment; and
wherein a size of a respective visual style indication corresponding to each of the at least one second segment in the second area is not proportional to a length of the corresponding second segment.

6. The method of claim 4, wherein a size of a respective visual style indication corresponding to each of the at least one first segment in the first area is equal to or exceed a lower limit size, and wherein a size of a respective visual style indication corresponding to each of the at least one second segment in the second area is equal to or exceed the lower limit size.

7. The method of claim 4, further comprising:
in response to detecting a selection of a first visual style indication corresponding to a target first segment in the first area, expanding the first visual style indication in the first area; and/or
in response to detecting a selection of a second visual style indication corresponding to a target second segment in the second area, expanding the second visual style indication in the second area.

8. The method of claim 7, further comprising:
in response to the first visual style indication being expanded, presenting, in association with the expanded first visual style indication, a time range occupied by the target first segment in the first video; and/or
in response to the second visual style indication being expanded, presenting, in association with the expanded second visual style indication, a time range occupied by the target second segment in the second video.

9. The method of claim 1, further comprising:
in response to detecting a selection of a first visual style indication corresponding to a target first segment in the first match indication information, presenting a secondary progress bar corresponding to the target first segment in an area other than a first progress bar of the first playback interface, the secondary progress bar being longer than a length of the target first segment; and/or
in response to detecting a selection of a second visual style indication corresponding to a target second segment in the second match indication information, presenting a secondary progress bar corresponding to the target second segment in an area other than a second progress bar of the second playback interface, the secondary progress bar being longer than a length of the target second segment.

10. The method of claim 1, wherein presenting first match indication information in an area associated with the first playback interface and second match indication information in an area associated with the second playback interface comprises:
presenting, in association with the first match indication information, a respective length indication of each of the at least one first segment; and
presenting, in association with the second match indication information, a respective length indication of each of the at least one second segment.

11. An electronic device comprising:
at least one processing unit; and
at least one memory coupled to the at least one processing unit and storing instructions for execution by the at least one processing unit, the instructions, when executed by the at least one processing unit, causing the electronic device to perform operations comprising:
presenting a first playback interface of a first video and a second playback interface of a second video; and
based on a content match result between the first video and the second video, presenting first match indication information in an area associated with the first playback interface and second match indication information in an area associated with the second playback interface,
wherein the first match indication information comprises a respective visual style indication corresponding to each of at least one first segment in the first video, and the second match indication information comprises a respective visual style indication corresponding to each of at least one second segment in the second video, and
wherein a first segment of the first video and a second segment of the second video that are indicated by the content match result as matched with each other are corresponding to same visual style indications, and a first segment of the first video and a second segment of the second video that are indicated by the content match result as unmatched with each other are corresponding to different visual style indications.

12. The electronic device of claim 11, wherein presenting first match indication information in an area associated with the first playback interface and second match indication information in an area associated with the second playback interface comprises:
presenting the first match indication information on a first progress bar of the first playback interface or in an adjacent area to the first progress bar; and
presenting the second match indication information on a second progress bar of the second playback interface or in an adjacent area to the second progress bar.

13. The electronic device of claim 12, wherein an extended length indicated by a respective visual style indication corresponding to each of the at least one first segment is the same as a length of a corresponding first segment on the first progress bar or in the adjacent area to the first progress bar; and
wherein an extended length indicated by a respective visual style indication corresponding to each of the at least one second segment is the same as a length of a corresponding second segment on the second progress bar or in the adjacent area to the second progress bar.

14. The electronic device of claim 11, wherein presenting first match indication information in an area associated with the first playback interface and second match indication information in an area associated with the second playback interface comprises:
presenting the first match indication information in a first area outside the first playback interface; and
presenting the second match indication information in a second area outside the second playback interface.

15. The electronic device of claim 14, wherein a size of a respective visual style indication corresponding to each of the at least one first segment in the first area is not proportional to a length of the corresponding first segment; and
wherein a size of a respective visual style indication corresponding to each of the at least one second segment in the second area is not proportional to a length of the corresponding second segment.

16. The electronic device of claim 14, wherein a size of a respective visual style indication corresponding to each of the at least one first segment in the first area is equal to or exceed a lower limit size, and wherein a size of a respective visual style indication corresponding to each of the at least one second segment in the second area is equal to or exceed the lower limit size.

17. The electronic device of claim 14, wherein the operations further comprise:
in response to detecting a selection of a first visual style indication corresponding to a target first segment in the first area, expanding the first visual style indication in the first area; and/or
in response to detecting a selection of a second visual style indication corresponding to a target second segment in the second area, expanding the second visual style indication in the second area.

18. The electronic device of claim 17, wherein the operations further comprise:
in response to the first visual style indication being expanded, presenting, in association with the expanded first visual style indication, a time range occupied by the target first segment in the first video; and/or
in response to the second visual style indication being expanded, presenting, in association with the expanded second visual style indication, a time range occupied by the target second segment in the second video.

19. The electronic device of claim 11, wherein the operations further comprise:
in response to detecting a selection of a first visual style indication corresponding to a target first segment in the first match indication information, presenting a secondary progress bar corresponding to the target first segment in an area other than a first progress bar of the first playback interface, the secondary progress bar being longer than a length of the target first segment; and/or
in response to detecting a selection of a second visual style indication corresponding to a target second segment in the second match indication information, presenting a secondary progress bar corresponding to the target second segment in an area other than a second progress bar of the second playback interface, the secondary progress bar being longer than a length of the target second segment.

20. A non-transitory computer readable storage medium having a computer program stored thereon, the computer program being executable by a processor to implement operations comprising:
presenting a first playback interface of a first video and a second playback interface of a second video; and
based on a content match result between the first video and the second video, presenting first match indication information in an area associated with the first playback interface and second match indication information in an area associated with the second playback interface,
wherein the first match indication information comprises a respective visual style indication corresponding to each of at least one first segment in the first video, and the second match indication information comprises a respective visual style indication corresponding to each of at least one second segment in the second video, and
wherein a first segment of the first video and a second segment of the second video that are indicated by the content match result as matched with each other are corresponding to same visual style indications, and a first segment of the first video and a second segment of the second video that are indicated by the content match result as unmatched with each other are corresponding to different visual style indications.
